(19) United States
(12) Patent Application Publication
(10) Pub. No.: US 2021/0142067 A1
(43) Pub. Date: May 13, 2021

(54) System and Method for Analyzing Sports Plays Using Dynamic Diagrams

(71) Applicant: ANALYZEMYTEAM LLC, Philadelphia, PA (US)

(72) Inventor: Denauld William Brown, Philadelphia, PA (US)

(73) Assignee: ANALYZEMYTEAM LLC, Philadelphia, PA (US)

(21) Appl. No.: 17/094,981

(22) Filed: Nov. 11, 2020

Related U.S. Application Data
(60) Provisional application No. 62/934,501, filed on Nov. 12, 2019.

(51) Int. Cl. G06K 9/00; A63B 24/00

(52) U.S. Cl. CPC G06K 9/00724; G06K 9/00744; A63B 2024/0025; G06K 2009/00738; A63B 2024/0028; A63B 24/0021

(57) ABSTRACT

A system and method for taking video of sports plays or various actions, recognizing pertinent objects, assigning diagrams to the recognized objects, and creating a dynamic diagram for analysis. The created diagram is useful for sports analytics and breaking down various sports plays. The created dynamic diagrams can be played back without the distractions of the original video. The motions and variable routes of the players and balls are tracked for analysis and prediction statistics.

### CROSS-REFERENCE

This application claims the benefit of U.S. Provisional Application No. 62/934,501 filed on Nov. 12, 2019, which application is incorporated herein by reference.

### BACKGROUND OF THE INVENTION

The standard way of watching and analyzing plays requires concentration, ability to pick out signs, and an ability to block out everything else going on in the video. Videos can lack video quality or can take up too much space or processing power. Moreover, watching and analyzing plays through videos can provide added distraction as watchers can be distracted by other actions happening in the video. The watcher may also be distracted by the different teams and players as teams and players they may know.

In some embodiments, the system and method for analyzing sports plays takes away from these distractions by providing dynamic diagrams instead of real-life players for play analysis. In some embodiments, the system and method detects and recognizes players, teams, fields, and sport equipment for isolation to be turned into dynamic diagrams to be analyzed.

In some embodiments, the disclosed system, method, and non-transitory computer readable medium is useful for sports analysis because: (1) when you visualize data it lets you create an exploratory environment where deeper insight can be discovered; and (2) detailed plans can be drafted, customized and implemented through the study of numerous dynamic simulations that will forecast potential outcomes.

### SUMMARY OF THE INVENTION

In some embodiments, a dynamic fabricator system includes one or more processors, and one or more memories operatively coupled to at least one of the one or more processors and having instructions stored thereon that, when executed by at least one of the one or more processors, cause at least one of the one or more processors to receive a video, wherein said video comprises a set of relevant objects, recognize said relevant objects, assign correlating diagrams for the set of relevant objects, continue to track said set of relevant objects' movements through a progression of said video, and create a new media including the correlating diagrams. In some embodiments, the new media further includes a set of diagrams indicating the movements of the set of relevant objects. In some embodiments, the dynamic fabricator system further includes compile a set of created new media, recognize different movements of the set of relevant objects, and compile the different movements into a compiled media, wherein compiled media comprises possible movements based on the different new media created. In some embodiments, the video is a sports play. In some embodiments, the set of recognized objects comprises players and a ball. In some embodiments, the set of recognized objects includes field markers. In some embodiments, the set of recognized objects comprises a players' team.

In some embodiments, a dynamic fabricator method includes receiving a video, wherein said video comprises a set of relevant objects, recognizing said relevant objects, assigning correlating diagrams for the set of relevant objects, continuing to track said set of relevant objects through a progression of said video, and creating a new media including the correlating diagrams. In some embodiments, the new media further includes a set of diagrams indicating the movements of the set of relevant objects. In some embodiments, the dynamic fabricator method further includes compiling a set of created new media, recognizing different movements of the set of relevant objects, and compiling the different movements into a compiled media, wherein compiled media comprises possible movements based on the different new media created. In some embodiments, the video is a sports play. In some embodiments, the set of recognized objects includes players and a ball. In some embodiments, the set of recognized objects includes field markers. In some embodiments, the set of recognized objects includes a players' team.

In some embodiments, a non-transitory computer-readable storage medium storing program instructions computer-executable to perform, includes receiving a video, wherein said video comprises a set of relevant objects; recognizing said relevant objects; assigning correlating diagrams for the set of relevant objects; continuing to track said set of relevant objects through a progression of said video; and creating a new media including the correlating diagrams. In some embodiments, the new media further includes a set of diagrams indicating the movements of the set of relevant objects. In some embodiments, the non-transitory computer-readable storage medium storing program instructions computer-executable to perform, further includes compiling a set of created new media, recognizing different movements of the set of relevant objects, and compiling the different movements into a compiled media, wherein compiled media comprises possible movements based on the different new media created. In some embodiments, the video is a sports play. In some embodiments, the set of recognized objects includes players and a ball. In some embodiments, the set of recognized objects includes field markers.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts an embodiment of the dynamic fabricator system change.

FIG. 2 illustrates an embodiment of the dynamic fabricator process.

FIG. 3 illustrates an embodiment of the merging of various data for the process of creating dynamic diagrams.

FIG. 4 illustrates an embodiment of the make-up of multiple modules feeding into a dynamic fabricator module set.

FIG. 5 depicts an embodiment of the user interface for analyzing video recordings.

FIG. 6 depicts an embodiment of the user interface for analyzing plays utilizing dynamic diagrams.

FIG. 7 depicts another embodiment of the dynamic fabricator system change.

FIG. 8 illustrates an embodiment of the data storage system feeding into predictive modules.

FIG. 9 depicts an embodiment of the predictive data system and user interface.

FIG. 10 illustrates one embodiment of the dynamic diagram's presentation.

FIG. 11 illustrates one embodiment of the dynamic fabricator method.

FIG. 12 depicts one embodiment of a system environment.

FIG. 13 depicts one embodiment of a comparison between exemplary football fields for NFL football and college (NCAA) football.

FIG. 14 depicts one embodiment of an exemplary transition field including a plurality of hash marks.

### DETAILED DESCRIPTION OF THE INVENTION

In some embodiments, a dynamic diagram fabricator system takes video, extracts relevant data, and creates dynamic diagrams for analysis. In some embodiments, a user selects a video to be analyzed. In some embodiments, the live video has an object recognition application run over the video to recognize people, relevant object, and relevant markers. In some embodiments, the recognized objects are given a correlating diagram. In some embodiments, the designated diagrams move in correlation to the motion of the recognized objects in the video. In some embodiments, the created diagrams are analyzed for performance improvements.

In some embodiments, the video depicts a sports play or a sports game. In some embodiments, the recognized objects are the players, the ball, and the field markers. In some embodiments, the object recognition differentiates teams by players' jersey colors. In some embodiments, the video is partitioned into packets correlating to different plates. In some embodiments, the dynamic diagram created includes the players, the ball, interval field markers, and movement of the objects. The assigned diagrams can be changed. Names or alternative symbols can be assigned to the diagrams.

In some embodiments, the dynamic fabricator system is an object-oriented video editing event management system. In some embodiments, the purpose of the system is to detect an array of objects during a kinetic event and to then refashion those objects into an animated diagram that mimics that event. In some embodiments, the now animated diagram or “dynamic diagram” includes any residual data associated with both the event and objects inside the event. In some embodiments, the dynamic diagram is integrated with other independent data sources to form analyzable data.

In some embodiments, the detection, object orientation, and diagram production aspects of the dynamic fabricator gives the system a wide spectrum of uses. The program can be used to diagram and/or map a wide variety of kinetic events including but not limited to: sporting events (i.e. football, basketball, baseball, soccer, ice hockey, track & field, lacrosse, and field hockey), agricultural events (i.e. grazing animals and tractor movements), transportation events (i.e. car travel, airport travel, and train travel), migration events (i.e. animal migration patterns), military events (i.e. military vehicle strategic movement), and commerce events (i.e. shipping patterns and trucking patterns).

In some embodiments, the dynamic fabricator system is a fully automated AI platform tracking player movements through deep homographies used to map targeted images on a grid of coordinates. A homography can describe the relation between two images of the same plane. Homography can be used for restructuring images and calculating the movement of the camera that took the images. In some embodiments, the dynamic fabricator system estimates homographies by mapping video frames from football video to the center of a top-down view of a football field with no human involvement.

In some embodiments, the dynamic fabricator system renders a dynamic (animated) diagram(s) from a recorded event that mimics the event, to map frame coordinates to real-world positions. In some embodiments, the now rendered dynamic diagram is derived from functions independently from the video it represents, as new “analyzable” data. The dynamic diagram functions can be independent of its video counterpart and can be used to visualize data in a unique way and simulate and scenarios. In some embodiments, the dynamic fabricator system tracks players from a recorded video and utilizes YOLO and part of its data stack. However, the dynamic fabricator system can still come down to the rendering of diagrams from video that function independently of the video and a new source of data.

In some embodiments, the dynamic fabricator system compiles a set of created diagram media. In some embodiments, the dynamic fabricator pairs data based on similarities in the media. In some embodiments, the similarities can be include the same sports play formation. The compiled data can be used to create an analysis media. The analysis media can include the possible movements of the players based on the different medias compiled. In some embodiments, the data is used to predict how the players are going to move.

In some embodiments, the dynamic fabricator system begins a camera, video source, recorded video, or live stream. In some embodiments, the system records field coordinates and football event from the received media. Then, real-time action recognition with tensor flow can be run on the media along with other possible applications to recognize the relevant data. In some embodiments, the raw video feeds into one user interface; the application rendered data feeds into different modules for analysis; and the application rendered data also feeds into a homography module. The raw video can be viewed in the video editor, the user dashboard, the video dynamic diagram library, the dynamic fabricator dashboard, or other interfaces along with or outside renderings of new media based on the analyzed data. In some embodiments, the data fed through different modules goes through modules related to but not limited to metadata stripping and identifying, queuing of data, indexing information and relevant data, searching for relevant key terms in metadata or external sources, checking for triggers based on different action based event triggers, and analyzing the collated data extracted for shadow analytics. In some embodiments, this information is fed into an application that creates a visual depiction of the data to be displayed on a user interface. In some embodiments, the homography data set is fed through a rendering application that renders a complete diagram to be cached with other relevant data and displayed for the user in a user interface window for analysis by the user. In some embodiments, a singular user interface window depicts all three data sets: raw media, analyzed data, and homography data set.

In some embodiments, the system can be used to analyze football plays. In some embodiments, the dynamic diagrams creation is completed with the x-axis being the yard lines, and the y-axis being the field width. In some embodiments, the x-axis is the width, and the y-axis is the yard lines.

The system can use a variety of object recognition applications, a variety of media compilers, a variety of video sources, a variety of numerical computation applications, a variety of analytics applications, a variety of APIs, a variety of data set compilers, a variety of machine learning applications, a variety of media players, a variety of video playback tools, a variety of user interface tools, a variety of library configurations, a variety of search techniques, and a variety of homography applications.

In some embodiments, the system utilizes a heuristic sequencing algorithm for learning based on the data fed into the system. In some embodiments, the system begins with a video capture or raw video of some sort. Then, the raw video can be fed through an object detection application. Then, the raw video can be fed into another object recognition application or can be sent to a video editor. In some embodiments, a matching algorithm is also run on the raw video. The video can be viewed. Data can be extracted from the raw video based on various attributes and data obtained. The video post-object detection can be fed into another object detection application or can be fed into an algorithm that refashions the video. The video can then be fed into the heuristic sequencing algorithm. The process can then begin again with the data collected to refine the process. In some embodiments, the refashioned video data is presented to the user for analysis and use.

In some embodiments, the system is accessed through a web login-based system. In some embodiments, the system stores data locally. In some embodiments, the data is stored externally. In some embodiments, an account must be made to access the application and data. In some embodiments, data is pooled by users. In some embodiments, the users' data is isolated from other users. In some embodiments, data sets are accessed through a purchase platform. In some embodiments, the data sets are accessed through a subscription service.

The dynamic fabricator system can rely on a method that can be implemented into a computer application or a non-transitory computer readable storage medium.

FIG. 1 depicts an embodiment of the dynamic fabricator system change. In some embodiments, the diagram of the dynamic fabricator (100) main screen which converts live and or recorded video clip(s) (105) into dynamic diagram(s) (110) focusing on certain objects (115) in the live video to translate into dynamic diagrams (120). In some embodiments, the process is comprehensive starting with a live video feed or a recorded video clip of an event (105). In some embodiments, once the event is captured on video the software locks on to the targeted objects (115) and begins the interpretation process. In some embodiments, after interpretation comes the fashioning process of those targeted objects into an animated diagram (120) of objects that mimics the original video clip.

FIG. 2 pinpoints some embodiments of the process of dynamic fabrication. In some embodiments, the dynamic fabrication (200) is a detection and extraction process that extracts real-time images of relevant objects specific to the industry and or subject matter from a recorded video clip. In some embodiments, the dynamic fabrication process extracts both static and moving objects, (215) and the process converts those moving objects into an animated diagram (220). Multiple diagrams can be created from one video clip depending on how many points of similarity and what filters are applied before and or after the fabrication process is complete. For example, the user interface can depict a football field, football players, and an industry standard of situational football. In some embodiments, the dynamic fabricator extracts relevant objects including but not limited to all 22 players (215), the ball (225), the referees, and potential penalty flags. In some embodiments, field dimensions are included as well as the field lines, numbers, and hash marks for a specific location on the field and schematic situation. In some embodiments, the extractions are refashioned into animated diagram(s) (210) (220) (230) that mimic the live feed and or recorded clip.

FIG. 3 depicts an embodiment of the refashioned video clip (305) merging with multiple data sources (310) to form a diagram, followed by a capture process that extracts the newly formed data to be used as both a situational simulator and a predictive analytic package (315). In some embodiments, there are multiple data sources (310) that can be purchased from many vendors. In some embodiments, these sources are generally based in statistics relevant to the industry.

FIG. 4 represents an embodiment of the system including multiple modules affected by the dynamic fabrication process. In some embodiments, data flows from the dynamic fabricator into the dynamic diagrams package (420). In some embodiments, the package includes: the player platform module (405), the pro scout module (410), and the recruit module (415).

In some embodiments, the player platform module (405) is a tracking module that schematically tracks individuals during an event and how both the location and the role of the individual can impact the outcome of that event. Statistical data can be produced during the event and can merge with post-fabricated data from the dynamic fabricator to create analyzable data for study and planning.

In some embodiments, the pro scout module (410) is a sporting industry specific. The module can be a forecasting module, projection-based player scouting, and player personnel solution that takes the post fabrication data. In some embodiment, the module uses the post fabrication data to project players player/team compatibility based on multiple variables and specific team needs.

In some embodiments, the recruit module (415) is sports industry specific. In some embodiments, the module is a recruiting platform that analyzes and projects player/team compatibility based on unique data that makes the projection ideal for both player and school.

FIG. 5 illustrates an embodiment of the dashboard that represents a system data flow. In some embodiment, the dashboard includes the manual inputting module of the fabrication process. In some embodiments, the dynamic fabricator system merges manually inputted data with post fabricated data to use as the driving engine of the predictive simulator. In some embodiments, the example user interface (500) portrays live video footage (520), schedule of plays (510), field positioning (515), action options (525), and playbook list (505) to aid users in analyzing various tapes. The user can select different plays to view based on the playbook list (505), or the user can select a different view or prediction application off of the action options (525).

FIG. 6 depicts an example of football industry specific manual input screens each modeling a different perspective. In some embodiments, the first screen represents a total team perspective inclusive of all 22 players in the scheme design. In some embodiments, a second screen represents a 12-player design called “skelly” or “7 on 7.” In some embodiments, the second screen is based on the passing elements of schematic designs. In some embodiments, the third screen represents the “9 on 7” aspect of the of manual fabrication a scheme design or run game element of the schematic design. In some embodiments, the user interface with play diagram (600) includes an offensive play potential chart (620) and a players list (615). In some embodiments, the rest of the user interface displays the players diagrams in the play including player 1 (605), player 2 (610), and player 3 (615).

FIG. 7 illustrates an embodiment of the translation of video recording to dynamic diagrams. In some embodiments, the dynamic fabricator (700) begins the process of converting video (705) into dynamic diagrams (710) through an object detection and identification process. In some embodiments, the process identifies relevant targeted objects (715) (725) during an event that tracks the objects' motion, captures the data, and then refashions the data into an animated diagram (720) (730) that mimics the original video clip. In some embodiments, the data is converted and compiled from two typical perspectives that are football industry specific. In some embodiments, the two views are a sideline view and an endzone view. In some embodiments, the system uses one view, and in some embodiments, the system uses more than two views. In some embodiments, each view merges together to frame the process of fabrication. In some embodiments, once the event or play is over, the framework begins to build objects in the fabricator that reflect the targeted objects captured within the boxed framework on the video clip. In some embodiments, the application uses the landscapes dimensions to measure and scale the event. In a football industry specific context the dimensions can include field lines, numbers, hash marks, etc. The objects can then be fashioned into an animated diagram that mimics the recorded clip. The solution on a broad scale can be customizable based on specific industry use and subject matter where dynamic fabrication can be imagined and utilized.

FIG. 8 illustrates an embodiment of the system environment. In some embodiments, the data warehouse (820) is the storage facility for all the recorded videos (805), post-fabricated data (810), and diagrams (815). The data can be received from a variety of source, both internally from the application (825) or externally from other sources (850). All of the data, diagrams, and video clips can be filtered out to produce smaller subsets of information (835) for use specific to the industry, utilizing the solution for various uses. Event sequences can be compiled and organized in the library and used to create simulated scenarios. These simulations can include customized filters tailored to the user. The user can be able to use filters to manipulate the data and customize the desired simulations. Multiple simulations can also run simultaneously. These simulations can be presented as a post simulation analysis for the outcomes present as detailed and comprehensive reports.

FIG. 9 displays an embodiment of the user interface of the dynamic predictor. In some embodiments, the dynamic predictor is an agile version of the dynamic fabricator. In some embodiments, the predictor module is used to funnel all the compiled data from the other modules (905) (910) (915) in the analyzing solution. In some embodiments, the data pools into the dynamic predictor (900) and generates predictions (920) based upon descriptive, exploratory, inferential, predictive, causal, and mechanistic analysis. In some embodiments, the agility of the predictor is for real-time application and for compiling data very quickly for situational application in an unpredictable environment. The dynamic predictor can anticipate patterns (920), which can lead to “scripting.” Scripting is an industry term used for the ordering of a sequence of coordinated events into one big event in order determined by the end user focused on the end goal. In some embodiments, the acute focus of the predictor is to make “suggestions” in anticipation of each individual event that factors in all the analyses. In some embodiments, the suggestions are specific to the end user and only factor in data that is input by the end user with the option of being supplemented by scenario simulations that can be factored in as unique data.

FIG. 10 depicts an embodiment of a data visualization screen (1000) that demonstrates the fabrication procession of the dynamic predictor. In some embodiments, the screen presents multiple screens for quick analysis of both individual and sequenced events. In some embodiments, the players (1015) (1025) (1010) (1005) (1020) displayed are running various routes in this predictive diagram (1000).

FIG. 11 depicts an embodiment of the dynamic fabricator method. In some embodiments, the dynamic fabricator application receives a video, wherein said video comprises a set of relevant objects (1105), recognizes said relevant objects (1115), assigns correlating diagrams for the set of relevant objects (1120), continues to track said set of relevant objects through a progression of said video (1125), and creates a new media including the correlating diagrams (1130). In some embodiments, the application further compiles a set of created new media (1135), recognizes different movements of the set of relevant objects (1140), and compiles the different movements into a compiled media (1145), wherein compiled media comprises possible movements based on the different new media created.

FIG. 12 depicts the system environment of one embodiment of the processing system. In some embodiments, the module (1220) includes storage media, system memory, new media creator (1205), object recognition application (1210), a processor (1235), and a database of algorithms. In some embodiments, the application intakes a video (1230), then relays the data to the processor (1235). In some embodiments, the processor receives data from other sources (1240) as well to know the intended purpose. The other sources may be manual input or a variety of other sources. In some embodiments, the processor intakes the data, recognizes relevant objects, assigns symbols to the objects, and creates a new form of media including the assigned symbols. In some embodiments, if objects are recognized, the new media creator (1205) sends information to the storage module. The module may also send instructions from the new media creator (1205) to the user's display (1215) to be viewed by the user.

FIG. 13 shows exemplary football fields for NFL football field (1300) and college (NCAA) football field (1305). A center area (1310), (1315) is shown for both fields. At the beginning of the game, the ball is positioned within the center area (1310), (1315). As shown in FIG. 13, the center area (1310) is narrower for the NFL football field (1300) than the center area (1315) for the college (NCAA) football field (1305).

FIG. 14 depicts an exemplary transition field including a plurality of hash marks. A transition field is a field that merges the field dimensions of both college (NCAA) football and NFL football using hash marks. In FIG. 14, transition field (1400) includes a plurality of hash marks (1405). The hash marks (1405) extend along the entire length of the transition field (1400) excluding an end zone area (not depicted). The hash marks (1405) are positioned parallel to the sidelines (1410). When the dynamic fabricator system detects that a ball crosses the boundary boarders of the sidelines (1410), the ball is considered out of bounds. In this situation, the ball is repositioned on the closest hash mark (1405) for the next play. In addition, when the dynamic fabricator system detects that a ball touches the ground between the sidelines (1410) and a hash mark (1405), the ball is also repositioned on the closest hash mark (1405) for the next play. The dynamic fabricator system uses the hash marks (1405) in analyzing the position of the ball and predicting the ball's movement.

In some embodiments, the two rows of hash marks (1405) are positioned parallel to each other at the center of the transition field (1400). The area between the two rows of hash marks (1405) define the center areas (1310), (1315) as shown in FIG. 13. The hash marks (1405) may be configured as small lines (e.g., 4 inches wide by 2 feet long) used to mark the 1-yard section between each of the 5-yard lines on the transition field (1400).

In NFL football, the hash marks (1405) are positioned 70 feet and 9 inches from the closest sideline (1410), thus giving the NFL center area (1310) defined by the two rows of hash marks (1405) a longitudinal length of 18 feet and 6 inches. On the other hand, in college (NCAA) football, the hash marks (1405) are closer to the sidelines (1410) and are positioned 60 feet from the closest sideline (1410). This gives the NCAA center area (1315) defined by the two rows of hash marks (1405) a longitudinal length of 40 feet apart. The transition field (1400) includes both the NFL center area (1310) and the NCAA center area (1315) in an alternating fashion along the length of the field. The purpose of the hash marks on the transition fields is to maximize the competitiveness of the sport. The hash marks may also be either predetermined or adjusted in real-time for additional competitiveness.

It should be understood by those skilled in the art that the distances and measurements presented in the present application are for illustrative purposes only and that other variations in distance or measurement lengths are possible in other embodiments not exhaustively disclosed herein.

In some embodiments, the embodiment further includes sending, receiving, or storing data, instructions, or both upon a computer-readable medium. Methods disclosed above may be accomplished by one computer or may be accomplished through a plurality of computers, and the method should not be construed as one or the other. The methods may be implemented in hardware, software, or an amalgamation of both. The systems, methods, and procedures disclosed herein can be embodied in a programmable computer, computer-executable software, or digital circuitry. The software can be stored on computer-readable media. Some examples of computer-readable media can include a RAM, ROM, floppy disk, hard disk, flash memory, memory stick, removable media, optical media, magneto-optical media, CD-ROM, or any other viable form. Digital circuitry can include, but not limited to, integrated circuits, building block logic, gate arrays, field programmable gate arrays, or any other viable form. In some embodiments, the method may be reordered, changed, additional steps added, steps removed, steps combined, and otherwise modified. In some embodiments, the steps are automated. Chronological wording such as first, second, third, and so forth should not be viewed as limiting, but instead as one possible embodiment.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A dynamic fabricator system comprising:
one or more processors; and
one or more memories operatively coupled to at least one of the one or more processors and having instructions stored thereon that, when executed by at least one of the one or more processors, cause at least one of the one or more processors to:
receive a video, wherein said video comprises a set of relevant objects;
recognize said relevant objects;
assign correlating diagrams for the set of relevant objects;
continue to track said set of relevant objects' movements through a progression of said video; and
create a new media including the correlating diagrams.

2. A dynamic fabricator system of claim 1, wherein the new media further comprises a set of diagrams indicating the movements of the set of relevant objects.

3. A dynamic fabricator system of claim 1, further comprising:
compile a set of created new media;
recognize different movements of the set of relevant objects; and
compile the different movements into a compiled media, wherein compiled media comprises possible movements based on the different new media created.

4. A dynamic fabricator system of claim 1, wherein the video is a sports play.

5. A dynamic fabricator system of claim 4, wherein the set of recognized objects comprises players and a ball.

6. A dynamic fabricator system of claim 4, wherein the set of recognized objects comprises field markers.

7. A dynamic fabricator system of claim 4, wherein the set of recognized objects comprises a players' team.

8. A dynamic fabricator method comprising:
receiving a video, wherein said video comprises a set of relevant objects;
recognizing said relevant objects;
assigning correlating diagrams for the set of relevant objects;
continuing to track said set of relevant objects through a progression of said video; and
creating a new media including the correlating diagrams.

9. A dynamic fabricator method of claim 8, wherein the new media further comprises a set of diagrams indicating the movements of the set of relevant objects.

10. A dynamic fabricator method of claim 8, further comprising:
compiling a set of created new media;
recognizing different movements of the set of relevant objects; and
compiling the different movements into a compiled media, wherein compiled media comprises possible movements based on the different new media created.

11. A dynamic fabricator method of claim 8, wherein the video is a sports play.

12. A dynamic fabricator method of claim 11, wherein the set of recognized objects comprises players and a ball.

13. A dynamic fabricator method of claim 11, wherein the set of recognized objects comprises field markers.

14. A dynamic fabricator method of claim 11, wherein the set of recognized objects comprises a players' team.

15. A non-transitory computer-readable storage medium storing program instructions computer-executable to perform, comprising:
receiving a video, wherein said video comprises a set of relevant objects;
recognizing said relevant objects;
assigning correlating diagrams for the set of relevant objects;
continuing to track said set of relevant objects through a progression of said video; and
creating a new media including the correlating diagrams.

16. A non-transitory computer-readable storage medium storing program instructions computer-executable to perform of claim 15, wherein the new media further comprises a set of diagrams indicating the movements of the set of relevant objects.

17. A non-transitory computer-readable storage medium storing program instructions computer-executable to perform of claim 15, further comprising:
compiling a set of created new media;
recognizing different movements of the set of relevant objects; and
compiling the different movements into a compiled media, wherein compiled media comprises possible movements based on the different new media created.

18. A non-transitory computer-readable storage medium storing program instructions computer-executable to perform of claim 15, wherein the video is a sports play.

19. A non-transitory computer-readable storage medium storing program instructions computer-executable to perform of claim 18, wherein the set of recognized objects comprises players and a ball.

20. A non-transitory computer-readable storage medium storing program instructions computer-executable to perform of claim 18, wherein the set of recognized objects comprises field markers.
